(19) United States
(12) Patent Application Publication
(10) Pub. No.: US 2006/0282391 A1
(43) Pub. Date: Dec. 14, 2006

(54) Method and apparatus for transferring protected content between digital rights management systems

(75) Inventors: Petr Peterka, San Diego, CA (US); Hosame H. Abu-Amara, Round Lake, IL (US); David W. Kravitz, Fairfax, VA (US); Alexander Medvinsky, San Diego, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/358,612

(22) Filed: Feb. 21, 2006

Related U.S. Application Data
(60) Provisional application No. 60/688,533, filed on Jun. 8, 2005.

(51) Int. Cl. H04L 9/00

(52) U.S. Cl. 705/57

(57) ABSTRACT

Method and apparatus for transferring protected content between digital rights management systems is described. One aspect of the invention relates to importing content from an upstream digital rights management (DRM) system into a device in a downstream DRM system. Data is received that associates at least one device in the downstream DRM system with a rights issuer module (RIM). Authenticity of the data is verified as originating from an entity in a trust hierarchy of the device. If the data is authentic and the device is one of the at least one device associated with the RIM, a ciphertext version of the content and a corresponding content license is accepted from the RIM.

### CROSS-REFERENCE TO RELATED APPLICATIONS

This application claims benefit of U.S. provisional patent application Ser. No. 60/688,533, filed Jun. 8, 2005, which is incorporated by reference herein.

### BACKGROUND OF THE INVENTION

1. Field of the Invention

The present invention relates to content distribution systems and, more particularly, to a method and apparatus for transferring protected content between digital rights management systems.

2. Description of the Background Art

Digital content has gained wide acceptance in the public. Such content includes, but is not limited to: movies, videos, music, and the like. Consequently, many consumers and businesses employ various digital media devices or systems that enable the reception of such digital multimedia content via several different communication channels (e.g., a wireless link, such as a satellite link, or a wired link, such as a cable connection). Similarly, the communication channel may also be a telephony based connection, such as DSL and the like. Regardless of the type of channel, the digital content and/or the distribution of the digital content is typically secured using some combination of conditional access and digital rights management (DRM) mechanisms (e.g., encryption/decryption using keys).

Currently, there is no single preferred content format or DRM system across all platforms. Consumers may possess several devices for processing content, each of which may employ a different DRM system for content protection. In some instances, consumers may desire to transfer content between devices that employ different DRM systems. Such transfer of content must include a corresponding transfer of content protection data between DRM systems, where such content protection data transfer may be initiated separately, perhaps over a distinct channel. Accordingly, there exists a need in the art for a user-centric method and apparatus for transferring protected content between digital rights management systems that does not require infrastructure support for each such transfer.

### SUMMARY OF THE INVENTION

Method and apparatus for transferring protected content between digital rights management systems is described. One aspect of the invention relates to importing content from an upstream digital rights management (DRM) system into a device in a downstream DRM system. Data is received that associates at least one device in the downstream DRM system with a rights issuer module (RIM) such that a particular device may be associated with more than one such RIM. Authenticity of the data is verified as originating from the upstream or downstream system infrastructure. If the data is authentic and the device is one of the at least one device associated with a particular RIM, a ciphertext version of the content and a corresponding content license is accepted from that RIM.

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a content distribution and protection architecture in accordance with one or more aspects of the invention;

FIG. 2 is a flow diagram depicting an exemplary embodiment of a method for transferring content from a rights issuer module to a downstream device in accordance with one or more aspects of the invention;

FIG. 3 is a flow diagram depicting an exemplary embodiment of a method for transferring content from a rights issuer module to a downstream device in accordance with one or more aspects of the invention;

FIG. 4 is a flow diagram depicting an exemplary embodiment of a method for transferring content from a rights issuer module to a downstream device in accordance with one or more aspects of the invention;

FIG. 5 is a flow diagram depicting an exemplary embodiment of a method for importing content from an upstream DRM system into a device in a downstream DRM system; and

FIG. 6 is a block diagram depicting an exemplary embodiment of a computer suitable for implementing the processes and methods described herein.

To facilitate understanding, identical reference numerals have been used, where possible, to designate identical elements that are common to the figures.

### DETAILED DESCRIPTION OF THE INVENTION

Method and apparatus for transferring protected content between digital rights management (DRM) systems is described. The DRM system in which the content originates is referred to as the upstream DRM system. The DRM system to which the content is imported is referred to as the downstream DRM system. Each of the DRM systems separately employs authenticated, content-specific licensing or rights issuance. In one embodiment, a DRM translation device is provided that is functionally disposed between the upstream DRM system and the downstream DRM system. The DRM translation device obtains content from one or more upstream devices or other upstream-content provisioning source(s) and distributes the content to one or more downstream devices.

The content is associated with content protection data (“content license”) that enables use of the content under specified conditions. For each content transfer, the DRM translation device translates the content license from the upstream DRM system to the downstream DRM system. To facilitate translation, the upstream DRM system infrastructure (“upstream content distribution system”) or downstream DRM system infrastructure (“downstream rights management system infrastructure”) provides an electronic message, digital certificate, or other type of signal or digital communication that expresses privileges, permissions, and/or constraints regarding relationships among downstream devices and DRM translation devices. Each such signal or digital communication may associate one or more downstream devices with one or more identified DRM translation devices. Each such signal or digital communication is configured such that its authenticity as originating from the appropriate DRM system infrastructure is verifiable by the DRM translation device(s) and/or the downstream device(s).

Particular content and its associated content license is only distributed by a DRM translation device, and/or accepted by downstream device(s), if an authentic signal or digital communication exists that permits the association of that DRM translation device and the downstream device(s). Alternatively, the particular content and its associated content license is only distributed if neither the DRM translation device nor relevant downstream device(s) are aware of any authentic signals or digital communications or other conditions that prohibit such association.

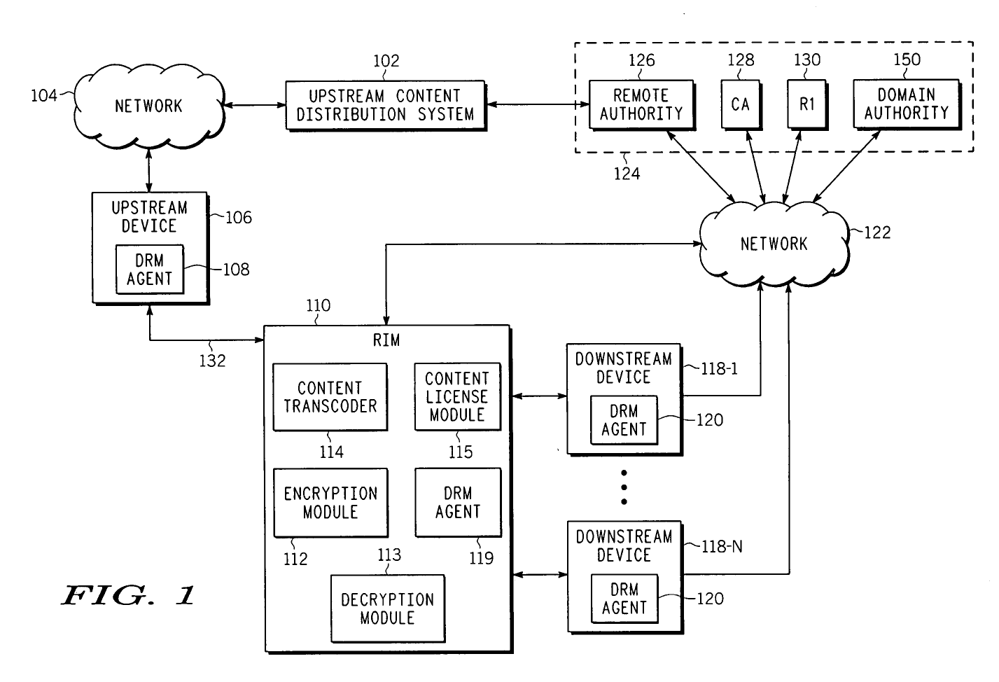

FIG. 1 is a block diagram of a content distribution architecture 100 in accordance with one or more aspects of the invention. The architecture 100 includes an upstream content distribution system 102, a network 104, an upstream device 106, a rights issuer module (RIM) 110, downstream devices 118-1 through 118-N (collectively referred to as downstream devices 118), a network 122, and a downstream rights management system infrastructure 124. The upstream content distribution system 102, the network 104, and the upstream device 106 comprise a portion of an upstream DRM system. The downstream devices 118, the network 122, and the downstream rights management system infrastructure 124 comprise a portion of a downstream DRM system. The RIM 110 functions as a DRM translation device that transfers content and associated content license data between the upstream and downstream DRM systems.

The content distribution system 102 may comprise a cable television system, telephone system, or the like that provides DRM-protected content for use by consumers. The network 104 may comprise a cable network, a telephone network, or the like. The upstream device 106 may comprise a set-top box (STB), digital video recorder (DVR), or like type device for processing and viewing DRM-protected content received from the content distribution system 102. The downstream devices 118 may include mobile devices, such as cellular telephones and digital music players (e.g., MP3 players), portable video players, media players in automobiles, and/or other types of devices not considered to be mobile, such as desktop computers. The downstream rights management system 124 may be operated by a mobile network operator (e.g., cellular telephone carrier), digital music/video provider, or the like that manages digital rights of content distributed to and consumed by the downstream devices 118. In the present embodiment, one or more components of the downstream rights management system infrastructure 124 may be involved in facilitating the management of digital rights of content that is derived from content originally distributed by the upstream content distribution system 102. The network 122 may comprise a wireless communication network (e.g., a cellular network), a packet network (e.g., the Internet, WiFi hotspots, etc.), or the like.

In one embodiment, the downstream DRM system employs a DRM scheme as specified by the Open Mobile Alliance (OMA) (http://www.openmobilealliance.org) or any equivalent DRM scheme. In the OMA DRM scheme, content licenses are referred to as rights objects (ROs). Each RO is specific to an item of content and either an individually identified downstream device or an identified domain of downstream devices. The downstream devices may obtain ROs from rights issuers (RIs). In one embodiment, ROs need not necessarily be generated or distributed by an RI. Those skilled in the art will appreciate that the downstream DRM system may employ other types of DRM schemes known in the art, such as one of the Windows Media Digital Rights Management (WMDRM) schemes specified by MICROSOFT.

The upstream content distribution system 102 provides content and associated content license data to the upstream device via the network 104. Effective use of an upstream content license to access a particular item of protected content may require that additional cryptographic data (e.g., a decryption key) be applied in order to unwrap cryptographic data (e.g., a wrapped Content Encryption Key (CEK)) that is included within the content license. The DRM data included within an upstream content license may specify various permissions and/or constraints associated with the item of content, such as whether or not the content can be played, displayed, or executed by upstream device 106, as well as the number of times or the length of time (or a time window during which) the content can be played, displayed, or executed. The upstream device 106 includes a DRM agent 108 (also referred to as an upstream DRM agent). The DRM agent 108 is configured to obtain upstream content licenses from the upstream content distribution system 102 for items of content. The DRM agent 108 also manages the authentication/verification of the upstream content license for a content item, the conditional access of the content item (e.g., decryption), and enforcement of the DRM permissions and/or constraints specified in the upstream content license as DRM data. Such permissions may itemize a list of (downstream) DRM systems for which export from the upstream DRM system (via translation) is allowed.

The RIM 110 is configured for communication with the upstream device 106. For example, the RIM 110 may be coupled to the upstream device 106 via a communication link 132. The communication link 132 may comprise any type of wireless or wired connection known in the art. Although the RIM 110 is shown as a separate element in FIG. 1, it is to be understood that the RIM 110 may be physically part of the upstream device 106. In the case that the RIM 110 is physically part of the upstream device 106, the RIM 110 may be securely configured to receive plaintext content (i.e., unencrypted content) and associated DRM data from the upstream device 106. Those skilled in the art understand that the entirety of plaintext is not available all at once as input to the RIM 110. Rather, only small increments such as video frames, network packets, access units, etc., are processed in clear text at any given time. Alternatively to plaintext input to the RIM 110, the RIM 110 may include a decryption module 113 for decrypting ciphertext content, provided by the upstream device 106, in order to obtain the plaintext content. In one example, this ciphertext content may be identical to that provided to the upstream device 106 via the upstream content distribution system 102, where the RIM 110 may include an upstream DRM agent capable of directly processing this ciphertext content. It is alternatively possible that the upstream device 106 decrypts content provided to it via the upstream content distribution system 102 prior to re-encrypting the content for use by the RIM 110. Rather than a RIM 110 serving a plurality of downstream devices 118, it is possible that a RIM 110 is incorporated directly into one or more such downstream devices 118.

In one embodiment, the RIM 110 includes a content transcoder 114. The content transcoder 114 is configured to transcode plaintext content obtained by the RIM 110 from one format to another. Such format changes may result in resolution loss and thus be non-reversible so that the resulting plaintext content is non-equivalent to the plaintext content from which it is derived. The content transcoder 114 may, for example, transcode content having an MPEG-2 format to an MPEG-4 format. Content may be transcoded to enable the content to be viewed/played/executed by the downstream devices 118. Use and/or inclusion of the content transcoder 114 are optional in that a particular downstream device may be capable of processing content based on the same plaintext formatting as that available initially to the upstream device 106.

The RIM 110 also includes an encryption module 112 and may contain a content license module 115. The encryption module 112 is configured to encrypt plaintext content (possibly transcoded) to produce a ciphertext version of the content. In one embodiment, the encryption module 112 employs a symmetric-key encryption algorithm such as the Advanced Encryption Standard (AES) algorithm. The cryptographic key used to encrypt the plaintext content is referred to herein as a content encryption key (CEK). The RIM 110 may generate CEKs used to encrypt items of content, or may use CEKs provided by other sources, such as the upstream DRM agent 108.

The RIM 110 may alternatively be termed a local rights issuer or limited rights issuer, consistent with inclusion of the content license module 115. The content license module 115 is configured to generate downstream content licenses for ciphertext content produced by the encryption module 112. Each downstream content license produced by the content license module 115 includes a function of the CEK, and DRM data, associated with a content item. Each downstream content license is cryptographically bound to a particular requesting downstream device or a domain in which the requesting device is a member, or must become a member as a prerequisite to effective use of the content license. A “domain” is a set of devices capable of sharing downstream content licenses for items of content. In one embodiment, for a given downstream device requesting a content item, the content license module 115 employs an asymmetric-key encryption algorithm to encrypt the CEK within the downstream content license (referred to as wrapping the CEK). For example, the content license module 115 may employ an RSA encryption scheme to wrap the CEK. The CEK is cryptographically bound to the requesting downstream device using a public-key provisioned in the device, thereby resulting in a wrapped CEK. The downstream device can decrypt the wrapped CEK by using its preferably secretly held private key. In another embodiment, the content license module 115 employs a symmetric-key encryption algorithm to wrap the CEK using a domain key associated with a domain. The downstream devices in a domain have the domain key, which they can use to decrypt the wrapped CEK. Each such downstream device in a domain initially acquires the domain key via use of its secretly held private key.

The RIM 110 is configured for communication with the downstream devices 118 and the network 122. For example, the RIM 110 may be coupled to each of the downstream devices via any type of wireless or wired communication link known in the art, such as a universal serial bus (USB) connection, FireWire connection, BLUETOOTH connection, wireless local area network (WLAN) connection, or the like. The RIM 110 may be (arbitrarily-) remotely coupled to a downstream device 118, as for example, via the Internet. Indirect communications between a RIM 110 and a downstream device 118, via, for example, removable media, may additionally, or alternatively, be enabled. The RIM 110 receives requests for content from the downstream devices 118. In response to a request, the RIM 110 verifies the authenticity of the downstream device. For example, each of the downstream devices 118 may be provisioned a digital certificate that includes a public key and is signed by an authority in the downstream DRM system. For a given request, the downstream device provides its digital certificate to the RIM 110. The RIM 110 processes the digital certificate to verify authenticity of the downstream device and its public key.

Each of the downstream devices 118 includes a DRM agent 120 (also referred to as the downstream DRM agent). The DRM agent 120 is configured to obtain downstream content licenses from the RIM 110 for items of content. The DRM agent 120 also manages the authentication/verification of the downstream content license for a content item, the conditional access of the content item (e.g., decryption), and enforcement of the DRM permissions specified in the downstream content license. Notably, the compliant DRM agent 120 will not accept a content item from the RIM 110 if the corresponding downstream device is not legitimately associated with the RIM 110. Exemplary embodiments of mechanisms for associating downstream devices with the RIM 110 are described below.

In one embodiment, the downstream rights management system infrastructure 124 provisions a digital certificate to the RIM 110. The digital certificate includes the public key of the RIM 110 and is signed by a certificate authority (CA) 128. The digital certificate further includes a field that identifies the RIM 110 as being authorized to issue content licenses and includes one or more identifiers of downstream devices assigned to the RIM 110. In one embodiment, the field including this information is a critical extension. A critical extension in a digital certificate must be acknowledged by compliant downstream devices. The downstream devices must reject the digital certificate if they are unable to fully process the critical extension.

The RIM 110 sends a requested content item and associated content license to a downstream device along with its digital certificate with the critical extension. The RIM 110 may check the identifier of the requesting downstream device against the list of device identifiers in the critical extension before sending the content and content license. The requesting downstream device, if compliant, will only accept the content and associated content license if its identifier is in the list of device identifiers in the critical extension. In this manner, the downstream DRM system maintains control over which downstream devices can receive content and content licenses from the RIM 110. A downstream device may be added to the list of devices associated with the RIM 110 by sending a request to the CA 128 from the RIM 110, from the requesting downstream device itself, or from an entity in the downstream DRM system. The CA 128 may require in-band or out-of-band proof that the requested addition of the downstream device identifier is justified. For example, the CA 128 may only add a device identifier to the digital certificate if the corresponding device is registered to a given user or household, and/or if the device is certified as meeting certain robustness or other requirements.

A device identifier may be deleted from the list in response to a request from the RIM 110 or upon request from an entity in the downstream DRM system. When a device identifier is added or deleted, the CA 128 issues a new digital certificate with the updated device identifier list to the RIM 110. The role of the CA 128 in adding or deleting device identifiers to certificates associated with the RIM 110 differs from Domain Authority 150 functionality in that the joining or leaving of devices relative to a domain typically involves key management functionality such as that relevant to acquisition and/or usage of domain keys by devices. The aforementioned role of the CA 128 is consistent with the use of either device rights objects or domain rights objects to enforce content licensing and is independent of this choice. In some configurations, the certification of the RIM 110 as associated with certain identified devices could be undertaken by the upstream content distribution system 102. For example, the upstream content distribution system 102 could be certified by CA 128 to act, in turn, in the role of issuing certificates for each of one or more RIM 110 units.

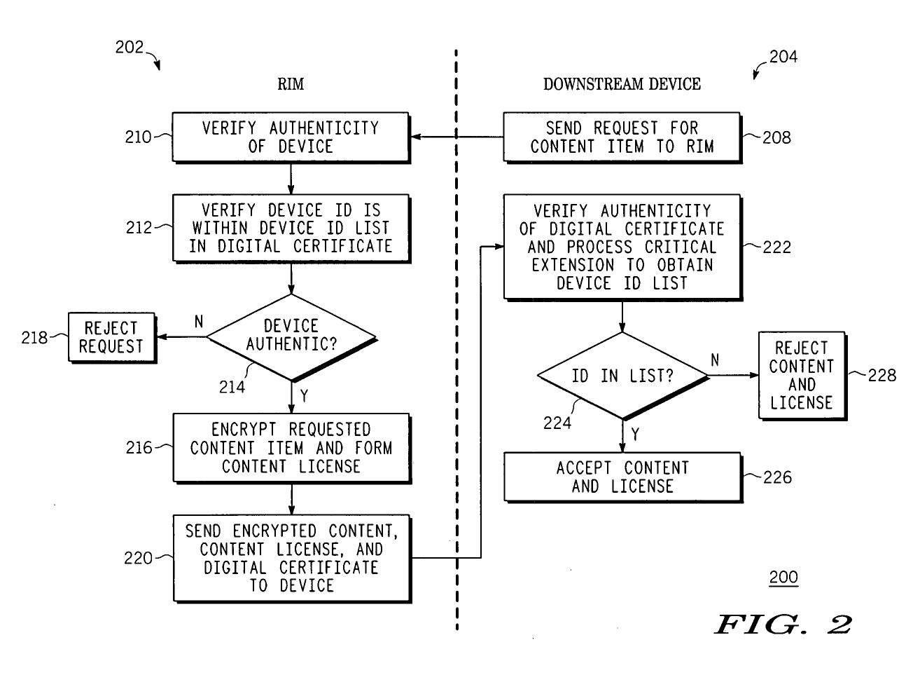

FIG. 2 is a flow diagram depicting an exemplary embodiment of a method 200 for transferring content from the RIM 110 to a downstream device in accordance with one or more aspects of the invention. In the present embodiment, the RIM 110 is provisioned with a digital certificate with a field having a list of device identifiers with which the RIM 110 is associated, where decisions regarding inclusion or exclusion of certain device identifiers relative to a given RIM 110 may be based on criteria set by the upstream and/or downstream DRM system(s). The method 200 includes a method 202 performed by the RIM 110, and a method 204 performed by the downstream device. The method 200 begins at step 208, where the downstream device sends a request for an item of content and associated downstream content license to the RIM 110. At step 210, the RIM 110 verifies the authenticity of the downstream device (e.g., via the digital certificate of the downstream device). At step 212, the RIM 110 optionally verifies that the identifier of the downstream device is within the list of device identifiers in its digital certificate. At step 214, if the downstream device is authentic, the method 200 proceeds to step 216. Otherwise, the method 200 proceeds to step 218, where the request is rejected. At step 216, the RIM 110 encrypts the requested content item and forms a content license. At step 220, the RIM 110 sends the encrypted content, the content license, and its digital certificate to the downstream device.

At step 222, the downstream device verifies the authenticity of the digital certificate and processes the critical extension to obtain the list of device identifiers. At step 224, if the identifier of the downstream device is in the list, the method 200 proceeds to step 226. Otherwise, the method 200 proceeds to step 228, where the content and the content license are rejected. At step 226, the downstream device accepts the content and associated content license.

Returning to FIG. 1, in another embodiment, the downstream rights management system infrastructure 124 provisions a digital certificate to the RIM 110. The digital certificate includes the public key of the RIM 110 and is signed by a certificate authority (CA) 128. The digital certificate further includes a field that identifies the RIM 110 as being authorized to issue content licenses. In one embodiment, the field including this information is a critical extension. In contrast to the previous embodiment, the critical extension does not include a list of device identifiers associated with the RIM 110. Rather, the downstream rights management system infrastructure 124 includes a remote authority 126. The remote authority 126 is configured to provide electronic messages to the RIM 110. An electronic message includes a list of device identifiers associated with the RIM 110 and is signed by the remote authority 126. The remote authority 126 may be certified by a certificate authority 128, but considered to be acting on behalf of one or more upstream DRM systems.

The RIM 110 sends a requested content item and associated content license to a downstream device along with its digital certificate with the critical extension and an electronic message with a list of device identifiers signed by the remote authority 126. The RIM 110 may check the identifier of the requesting downstream device against the list of device identifiers in the electronic message before sending the content and content license. The requesting downstream device will only accept the content and associated content license if its identifier is in the list of device identifiers in the electronic message. In this manner, the downstream DRM system maintains control over which compliant downstream devices can receive content and content licenses from the RIM 110, even if the RIM 110 attempts to violate this condition. In one embodiment, the remote authority 126 is certified by the downstream DRM system, but acts on behalf of the upstream DRM system. The upstream content distribution system 102 is configured for communication with the remote authority 126. The upstream DRM system controls which downstream devices are added or deleted from the list of device identifiers associated with the RIM 110.

A downstream device may be added to the list of devices associated with the RIM 110 by sending a request to the remote authority 126 from the RIM 110, from the requesting downstream device itself, or from an entity in the upstream DRM system. The remote authority 126 may require in-band or out-of-band proof that the requested addition of the downstream device identifier is justified. For example, the remote authority 126 may only add a device identifier to the list associated with the RIM 110 if the corresponding device is registered to a given user or household. A device identifier may be deleted from the list in response to a request from the RIM 110 or upon request from an entity in the upstream DRM system. When a device identifier is added or deleted, the remote authority 126 sends a new electronic message with the updated device identifier list to the RIM 110. The electronic messages may be configured to expire after a period of time. The remote authority 126 may periodically send new electronic messages to the RIM 110 regardless of whether devices have been added or deleted from the list.

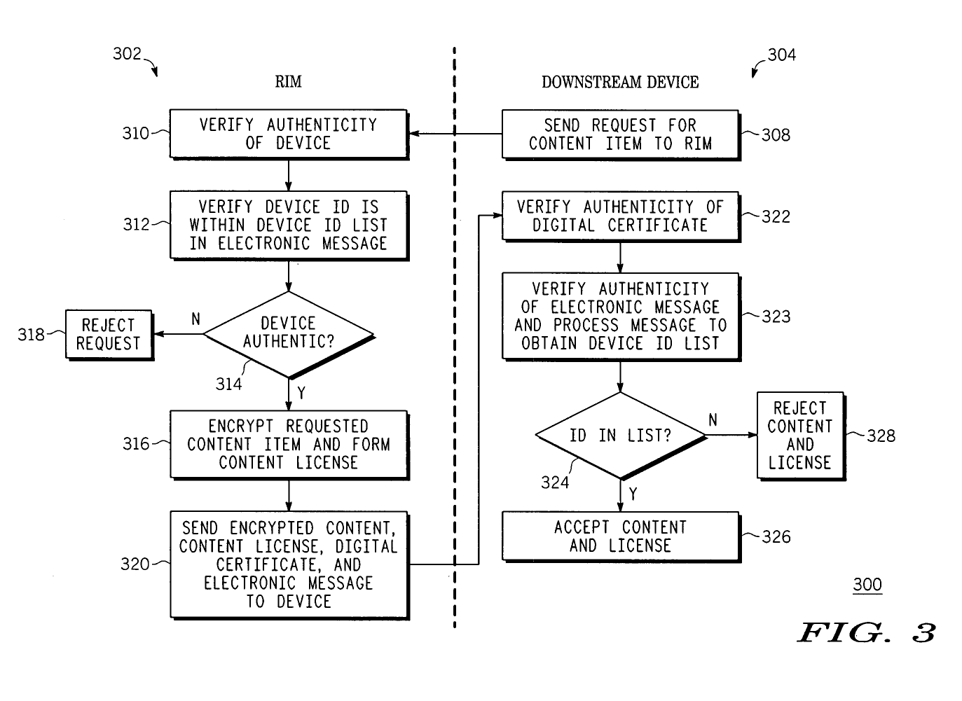

FIG. 3 is a flow diagram depicting an exemplary embodiment of a method 300 for transferring content from the RIM 110 to a downstream device in accordance with one or more aspects of the invention. In the present embodiment, the RIM 110 is provisioned a digital certificate with a field that identifies the RIM 110 as being authorized to distribute content licenses. The RIM 110 also obtains an electronic message signed by the remote authority 126 having a list of device identifiers with which the RIM 110 is associated. The method 300 includes a method 302 performed by the RIM 110, and a method 304 performed by the downstream device. The method 300 begins at step 308, where the downstream device sends a request for an item of content and associated downstream content license to the RIM 110. At step 310, the RIM 110 verifies the authenticity of the downstream device (e.g., via the digital certificate of the downstream device). At step 312, the RIM 110 optionally verifies that the identifier of the downstream device is within the list of device identifiers in the electronic message. At step 314, if the downstream device is authentic, the method 300 proceeds to step 316. Otherwise, the method 300 proceeds to step 318, where the request is rejected. At step 316, the RIM 110 encrypts the requested content item and forms a content license. At step 320, the RIM 110 sends the encrypted content, the content license, its digital certificate, and the electronic message to the downstream device.

At step 322, the downstream device verifies the authenticity of the digital certificate and processes the critical extension to verify that the RIM 110 is authorized to distribute content licenses. At step 323, the downstream device verifies the authenticity of the electronic message and processes the message to obtain the list of device identifiers. At step 324, if the identifier of the downstream device is in the list, the method 300 proceeds to step 326. Otherwise, the method 300 proceeds to step 328, where the content and the content license are rejected. At step 326, the downstream device accepts the content and associated content license.

Returning to FIG. 1, in one embodiment, a domain scheme may be employed within the downstream DRM system in the context of interaction with a RIM 110. As described above, a domain is a group of devices able to share content through a common content license. To access content assigned to a domain, each device must individually enroll in that domain. Enrollment in a domain is managed and administered by a domain authority. A domain key is used to wrap the CEK within each content license. Domains can be upgraded with a new domain key (e.g., if a device is compromised). Access to the old domain keys may be maintained using a hash-chain mechanism. In the embodiments of associating downstream devices to the RIM 110 described above, domain key distribution may be locally managed by the RIM 110. That is, the RIM 110 acts as a (local) domain authority through which the downstream devices may join or leave the domain. The downstream devices may still only accept content and content licenses if they verify their association with the RIM 110 either through a digital certificate or an electronic message. In an alternative embodiment, the RIM 110 may be configured to directly enforce device membership, where the certificate generated for the RIM 110 may indicate that compliant devices need not check further data in order to fully associate with RIM 110. Such an autonomous enforcement mechanism, based, for example, on hard-wired limit(s) within the RIM 110 on the number and/or types of devices with which it can associate, can be implemented in the context of device rights objects and/or domain rights objects.

In one embodiment, the data associating downstream devices to the RIM 110 may also include Hash(DK₀), where DK₀ is an initial domain key value and Hash is a hash function. Any key in the chain can be hashed successively at the device until this value is verified. For example, if KM is the master domain key, then:
DKₙ=KM
DKₙ₋₁=Hash(DKₙ)
DKₙ₋₂=Hash(DKₙ₋₁)
. . .
DK₀=Hash(DK₁)
DK₋₁=Hash(DK₀),
where DK₁ is incorporated in the data associating the downstream devices to the RIM 110.

In another embodiment, the downstream devices 118 are configured to receive registration trigger messages from an RI 130 in the downstream rights management system 124. The registration trigger message includes a list of identifiers for RIMs from which the downstream device is authorized to receive content. The registration trigger message is signed by the RI 130 such that the downstream device can verify the authenticity of the registration trigger message. In response to a verified registration trigger message that identifies the RIM 110, a downstream device attempts to register with the RIM 110. Registration is a security information exchange and handshake between a downstream device and the RIM 110. Successful completion of the registration process between a downstream device and the RIM 110 allows the downstream device to request and receive content and content licenses from the RIM 110.

In particular, a downstream device sends a request for an item of content to the RIM 110. The downstream device can only request and receive content from RIMs with which it is associated through the registration trigger messages. The RIM 110 sends a requested content item and associated content license to the downstream device. In this manner, the downstream DRM system maintains control over which downstream devices can receive content and content licenses from the RIM 110. A RIM may be added to the list of authorized RIMs or deleted from the list by sending additional registration trigger messages to the downstream device.

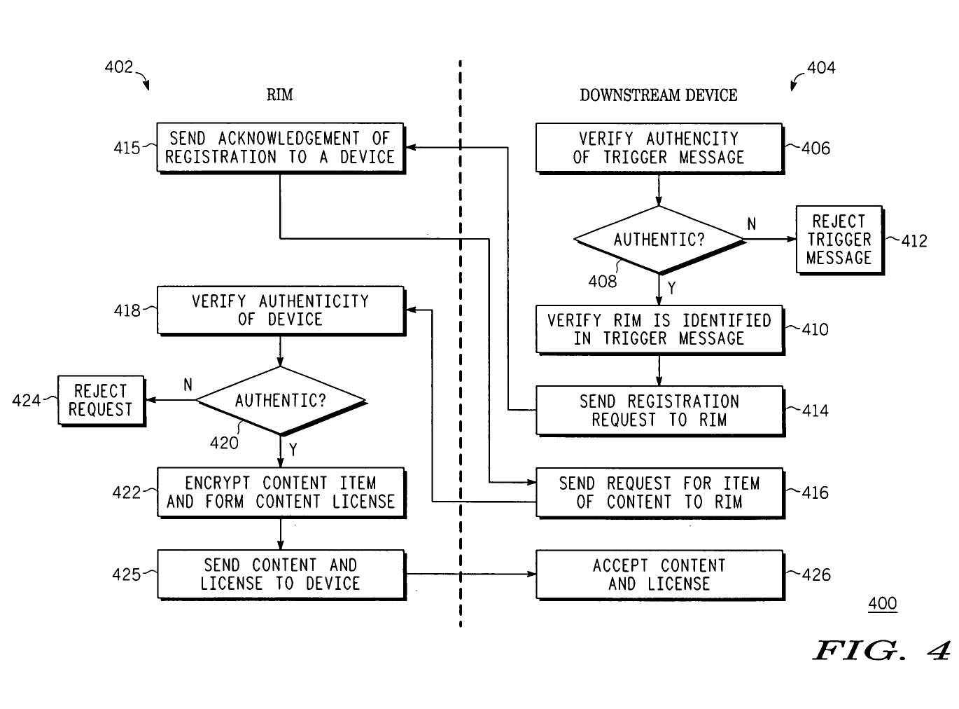

FIG. 4 is a flow diagram depicting an exemplary embodiment of a method 400 for transferring content from the RIM 110 to a downstream device in accordance with one or more aspects of the invention. In the present embodiment, the downstream device obtains a registration trigger message from the downstream DRM system that identifies the RIM 110 as being authorized to distribute content licenses. The method 400 includes a method 402 performed by the RIM 110, and a method 404 performed by the downstream device. The method 400 begins at step 406, where the downstream device verifies the authenticity of the registration trigger message (e.g., via a digital certificate associated with the RI that sent the trigger message). At step 408, if the registration trigger message is authentic, the method 400 proceeds to step 410. Otherwise, the method 400 proceeds to step 412, where the downstream device rejects the registration trigger message.

At step 410, the downstream device verifies that the RIM 110 is identified in the registration trigger message. At step 414, the downstream device sends a registration request to the RIM 110. At step 415, the RIM 110 sends an acknowledgement of registration to the downstream device. At step 416, the downstream device sends a request for an item of content and associated downstream content license to the RIM 110. At step 418, the RIM 110 verifies the authenticity of the downstream device (e.g., via the digital certificate of the downstream device). At step 420, if the downstream device is authentic, the method 400 proceeds to step 422. Otherwise, the method 400 proceeds to step 424, where the request is rejected. At step 422, the RIM 110 encrypts the requested content item and forms a content license. At step 425, the RIM 110 sends the encrypted content and the content license to the downstream device. At step 426, the downstream device accepts the content and associated content license.

Returning to FIG. 1, in the registration trigger message embodiment, if a domain scheme is employed, domain key distribution may be remotely managed by the downstream DRM system. Accordingly, the downstream rights management system 124 may include a domain authority 150. The RIM 110 includes a DRM agent 119 and is configured to become a member of a domain via communication with the domain authority 150. The RIM 110 generates content licenses specifically tied to the domain. One or more of the downstream devices 118 can join the domain by requesting such from the domain authority 150. The downstream devices 118 only accept content licenses from the RIM 110 if they are associated with the RIM via receipt of a registration trigger message.

Notably, in the previous described embodiments where the registration trigger messages were not employed, a device may still need to register with the RIM 110 in order to legitimately process device or domain rights objects generated by the RIM 110. Furthermore, such registration with the RIM or with a standard RI may be a pre-requisite for joining a domain managed by the RIM or standard RI, respectively.

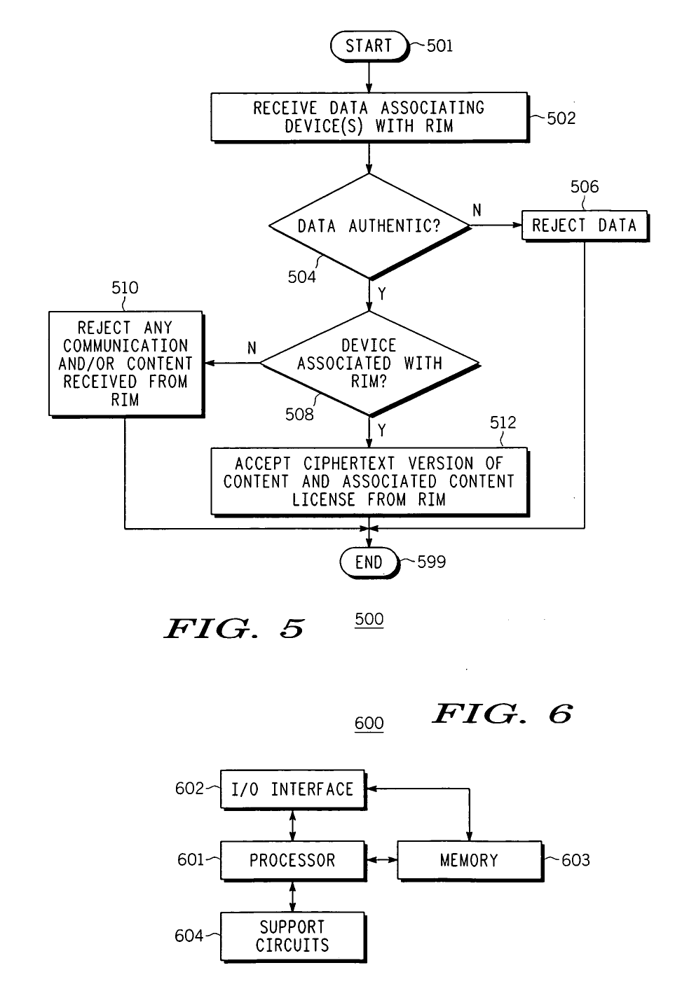

FIG. 5 is a flow diagram depicting an exemplary embodiment of a method 500 for importing content from an upstream DRM system into a device in a downstream DRM system. The method 500 begins at step 501. At step 502, data associating at least one device with a RIM is received at the device. In one embodiment, the data comprises a digital certificate with a critical extension having a list of device identifiers associated with the RIM. In another embodiment, the data comprises an electronic message signed by a remote authority that includes a list of device identifiers associated with the RIM. In yet another embodiment, the data comprises a registration trigger message signed by an authorized rights issuer that includes a list of RIMs from which the device may receive content. At step 504, a determination is made whether the data is authentic. If not, the method 500 proceeds to step 506, where the data is rejected by the device. From step 506, the method 500 ends at step 599.

If the data is determined to be authentic at step 504, the method 500 proceeds to step 508. At step 508, a determination is made whether the device is associated with the RIM using the data obtained at step 502. If the device is not associated with the RIM, the method 500 proceeds to step 510, where the device rejects any communication with the RIM and/or any content received from the RIM. From step 510, the method 500 ends at step 599. If the device is associated with the RIM, the method 500 proceeds from step 508 to step 512. At step 512, a ciphertext version of the content and an associated content license is accepted from the RIM. The method 500 then ends at step 599.

FIG. 6 is a block diagram depicting an exemplary embodiment of a computer 600 suitable for implementing the processes and methods described herein. The computer 600 may be used to implement the RIM 110. The computer 600 may also be used to implement the DRM agent 120 in a downstream device. The computer 600 includes a processor 601, a memory 603, various support circuits 604, and an I/O interface 602. The processor 601 may be any type of processor known in the art. The support circuits 604 for the processor 601 include conventional cache, power supplies, clock circuits, data registers, I/O interfaces, and the like. The I/O interface 602 may be directly coupled to the memory 603 or coupled through the processor 601.

The memory 603 may store all or portions of one or more programs, program information, and/or data to implement the functions of the RIM 110 or the DRM agent 120. Although the present embodiment is disclosed as being implemented as a computer executing a software program, those skilled in the art will appreciate that the invention may be implemented in hardware, software, or a combination of hardware and software. Such implementations may include a number of processors independently executing various programs and dedicated hardware, such as ASICs.

An aspect of the invention is implemented as a program product for use with a computer system. Program(s) of the program product defines functions of embodiments and can be contained on a variety of signal-bearing media, which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to illustrative embodiments of the present invention, other and further embodiments of the invention may be devised without departing from the basic scope thereof, and the scope thereof is determined by the claims that follow.

What is claimed is:

1. A method of importing content from an upstream digital rights management (DRM) system into a device in a downstream DRM system, comprising:
obtaining data associating at least one device with a rights issuer module (RIM);
verifying authenticity of the data as originating from an entity in a trust hierarchy of the device; and
if the data is authentic and the device is one of the at least one device associated with the RIM, accepting a ciphertext version of the content and a content license associated with the content from the RIM.

2. The method of claim 1, wherein the content license includes DRM data associated with the content and a representation of a content encryption key used to encrypt a plaintext version of the content received from an upstream DRM agent to produce the ciphertext version, the representation of the content encryption key being cryptographically bound to the device or a domain.

3. The method of claim 1, wherein the data comprises a digital certificate associated with the RIM and signed by a certificate authority in the downstream DRM system, the digital certificate including a field having at least one device identifier respectively associated with the at least one device.

4. The method of claim 3, wherein the field comprises a critical extension of the digital certificate.

5. The method of claim 3, wherein the step of verifying authenticity of the data comprises:
verifying, at the device, the digital certificate as being signed by the certificate authority;
wherein the content license is accepted by the device only if an identifier of the device is one of the at least one device identifier in the digital certificate and the digital certificate is authentic.

6. The method of claim 1, wherein the data comprises an electronic message signed by an authority certified by the downstream DRM system, the electronic message including a field having at least one device identifier respectively associated with the at least one device.

7. The method of claim 6, wherein the step of verifying authenticity of the data comprises:
verifying the electronic message as being signed by the authority at the device;
wherein the content license is accepted by the device only if an identifier of the device is one of the at least one device identifier in the electronic message and the electronic message is authentic.

8. The method of claim 1, wherein the data comprises a registration trigger message signed by an authorizing rights issuer in the downstream DRM system, the registration trigger message including a field having at least one identifier associated with a respective at least one RIM.

9. The method of claim 8, wherein the step of verifying authenticity of the data comprises:
verifying the registration trigger message as being signed by the authorizing rights issuer at the device;
wherein the content license is accepted by the device only if an identifier of the RIM is one of the at least one identifier in the registration trigger message and the registration trigger message is authentic.

10. The method of claim 1, wherein the data is generated by the RIM under control of the upstream DRM system.

11. The method of claim 1, wherein the data is generated by at least one of the upstream DRM system and the downstream DRM system.

12. The method of claim 1, wherein the data is generated by the upstream DRM system, the upstream DRM system being certified to generate the data by the downstream DRM system.

13. The method of claim 1, wherein the data includes a hash of an initial domain key value.

14. A method of processing content from an upstream digital rights management (DRM) system for importation into a device in a downstream DRM system, comprising:
receiving data that associates at least one device with a rights issuer module (RI M);
providing the data to one or more of the at least one device;
if the device is one of the at least one device:
encrypting a plaintext version of the content to produce a ciphertext version of the content;
generating a content license associated with the content for the device; and
providing the ciphertext version of the content and the content license to the device.

15. The method of claim 14, further comprising:
obtaining information indicative of the plaintext version of the content from an upstream DRM agent;
receiving DRM data for the content established by the upstream DRM system;
wherein the plaintext version of the content is encrypted using a content encryption key; and
wherein the content license includes a representation of the DRM data and a representation of the content encryption key, the representation of the content encryption key within the content license being cryptographically bound to the device or a domain.

16. The method of claim 14, wherein the data comprises a digital certificate associated with the RIM and signed by a certificate authority in the downstream DRM system, the digital certificate including a field having at least one device identifier respectively associated with the at least one device.

17. The method of claim 16, wherein the field comprises a critical extension of the digital certificate.

18. The method of claim 14, wherein the data comprises an electronic message signed by an authority certified by the downstream DRM system, the electronic message including a field having at least one device identifier respectively associated with the at least one device.

19. The method of claim 14, further comprising:
transcoding the plaintext version of the content prior to encryption.

20. Apparatus for importing content from a rights issuer module (RIM) to a device, comprising:
an encryption module for encrypting a plaintext version of the content received from an upstream digital rights management (DRM) system to produce a ciphertext version of the content;
a content license module for generating a content license associated with the content for the device; and
a DRM agent for obtaining data associating at least one device with the RIM, verifying authenticity of the data as originating from an entity in a trust hierarchy of the device, and accepting the content license only if the device is one of the at least one device associated with the RIM and the data is authentic.

21. The apparatus of claim 20, wherein the encryption module is configured to encrypt the plaintext version of the content using a content encryption key, and wherein the content license module is configured to receive DRM data for the content established by the upstream DRM system and generate the content license to include a representation of the DRM data and a representation of the content encryption key, the representation of the content encryption key being cryptographically bound to the device or a domain, the representation of the DRM data being based entirely or in part on the DRM data and realized in a form accessible by a downstream DRM system.

22. The apparatus of claim 20, wherein the data comprises a digital certificate associated with the RIM and signed by a certificate authority in a downstream DRM system, the digital certificate including a field having at least one device identifier respectively associated with the at least one device.

23. The apparatus of claim 20, wherein the data comprises an electronic message signed by an authority certified by a downstream DRM system, the electronic message including a field having at least one device identifier respectively associated with the at least one device.

24. The apparatus of claim 20, wherein the data comprises a registration trigger message signed by an authorizing rights issuer in a downstream DRM system, the registration trigger message including a field having at least one identifier associated with a respective at least one RIM.

25. The apparatus of claim 20, wherein the RIM is configured to generate the data under control of the upstream DRM system.

26. The apparatus of claim 20, wherein the data is generated by at least one of the upstream DRM system or a downstream DRM system.

27. The apparatus of claim 20, wherein the data is generated by the upstream DRM system, the upstream DRM system being certified to generate the data by a downstream DRM system.

28. The apparatus of claim 20, wherein the data includes a hash of an initial domain key value.
